(19) United States
(12) Patent Application Publication
(10) Pub. No.: US 2014/0001278 A1
(43) Pub. Date: Jan. 2, 2014

(54) EDUCTOR SYSTEM

(71) Applicants: James Alroy E. Hagquist, St. Paul, MN (US); Robert M. Hume, III, Woodbury, MN (US); Terrance L. Lund, Woodbury, MN (US); Roderick I. Lund, Woodbury, MN (US)

(72) Inventors: James Alroy E. Hagquist, St. Paul, MN (US); Robert M. Hume, III, Woodbury, MN (US); Terrance L. Lund, Woodbury, MN (US); Roderick I. Lund, Woodbury, MN (US)

(73) Assignee: EARTHCLEAN CORPORATION, South St. Paul, MN (US)

(21) Appl. No.: 13/977,996

(22) PCT Filed: Nov. 29, 2011
(86) PCT No.: PCT/US11/62306

§ 371 Date: Aug. 7, 2013

Related U.S. Application Data
(60) Provisional application No. 61/432,726, filed on Jan. 14, 2011.

(51) Int. Cl. B01F 5/04

(52) U.S. Cl. CPC B01F 5/04
USPC 239/10; 239/398

(57) ABSTRACT

An eductor system includes an eductor body having an eductor outlet and a motive fluid inlet being generally orthogonal to the eductor outlet, a suction nozzel disposed within the eductor body and co-axial with the eductor outlet, the suction nozzle extending between a nozzle proximal end and a nozzle distal end, the nozzle proximal end is fixed to the eductor body; and a suction tube element slidably disposed within the suction nozzle.

### BACKGROUND

An eductor system can used to continuously mix or combine a solute (e.g., powder or particulate or other fluidizable material) and a solvent or working fluid to form a dispersion, slurry or solution or gel. In certain applications such as fire fighting applications, it may be necessary to rapidly combine fire fighting solute and solvent (i.e., water) for application onto a fire. In many eductor systems, parts of the eductor can become clogged or difficult to clean, during eduction or after the solute and solvent is educted.

### BRIEF SUMMARY

The present disclosure relates to eductor systems that can effectively combine a powder or liquid concentrate solute and water. In particular the present disclosure relates to eductor systems that effectively combine a powder or liquid concentrate solute and water to form a firefighting gel and are easy to maintain and clean.

In one illustrative embodiment, an eductor system includes an eductor body having an eductor outlet and a motive fluid inlet being generally orthogonal to the eductor outlet, a suction nozzel disposed within the eductor body and co-axial with the eductor outlet, the suction nozzle extending between a nozzle proximal end and a nozzle distal end, the nozzle proximal end is fixed to the eductor body; and a suction tube element slidably disposed within the suction nozzle.

In another illustrative embodiment, an apparatus includes a vehicle, a liquid reservoir disposed on the vehicle, a liquid recirculation loop fluidly connected to the liquid reservoir to recirculate liquid in the liquid reservoir, and an eductor disposed in the liquid recirculation loop to combine a composition with the liquid. The eductor includes an eductor body having an eductor outlet and a motive fluid inlet being generally orthogonal to the eductor outlet, a suction nozzel disposed within the eductor body and co-axial with the eductor outlet, the suction nozzle extending between a nozzle proximal end and a nozzle distal end, the nozzle proximal end is fixed to the eductor body, and a suction tube element slidably disposed within the suction nozzle.

In another illustrative embodiment, a method includes flowing a motive fluid through an eductor to form a low pressure region in the educator, flowing a pseudoplastic forming composition through a suction nozzle wherein the suction nozzle extends into the low pressure region and the suction nozzle comprises a suction tube element slidably disposed within the suction nozzle, and combining the pseudoplastic forming composition with motive fluid in the low pressure region to form a pseudoplastic composition that forms an exterior intumescent char coating upon fire contact.

These and various other features and advantages will be apparent from a reading of the following detailed description.

### BRIEF DESCRIPTION OF THE DRAWINGS

The disclosure may be more completely understood in consideration of the following detailed description of various embodiments of the disclosure in connection with the accompanying drawings, in which:

FIG. 1 is a schematic diagram of an illustrative eductor system;

FIG. 2 is a perspective view of an illustrative eductor body;

FIG. 3 is a schematic side view of an illustrative eductor body; and

FIG. 4 is a schematic cross-sectional view of an illustrative eductor body taken along line 3-3.

The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

In the following description, it is to be understood that other embodiments are contemplated and may be made without departing from the scope or spirit of the present disclosure. The following detailed description, therefore, is not to be taken in a limiting sense.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

As used in this specification and the appended claims, the singular forms “a”, “an”, and “the” encompass embodiments having plural referents, unless the content clearly dictates otherwise. As used in this specification and the appended claims, the term “or” is generally employed in its sense including “and/or” unless the content clearly dictates otherwise.

The present disclosure relates to eductor systems that can effectively combine a powder or liquid concentrate solute and water. In particular the present disclosure relates to eductor systems that effectively combine a powder or liquid concentrate solute and water to form a firefighting gel and are easy to maintain and clean. A suction tube element can be slidably engaged with a suction nozzle within the eductor body so that after the solute and solvent are combined, the suction tube element and any solute residue remaining in the suction tube is removed from the eductor body. The solute can be a pseudoplastic forming composition that when combined with water, forms a psuedoplastic composition. The pseudoplastic composition can include starch, a pseudoplastic, high yield, suspending agent, and water. The pseudoplastic composition can cling to a surface positioned in any orientation. The pseudoplastic composition can form an intumescent char coating upon fire contact. While the present disclosure is not so limited, an appreciation of various aspects of the disclosure will be gained through a discussion of the examples provided below.

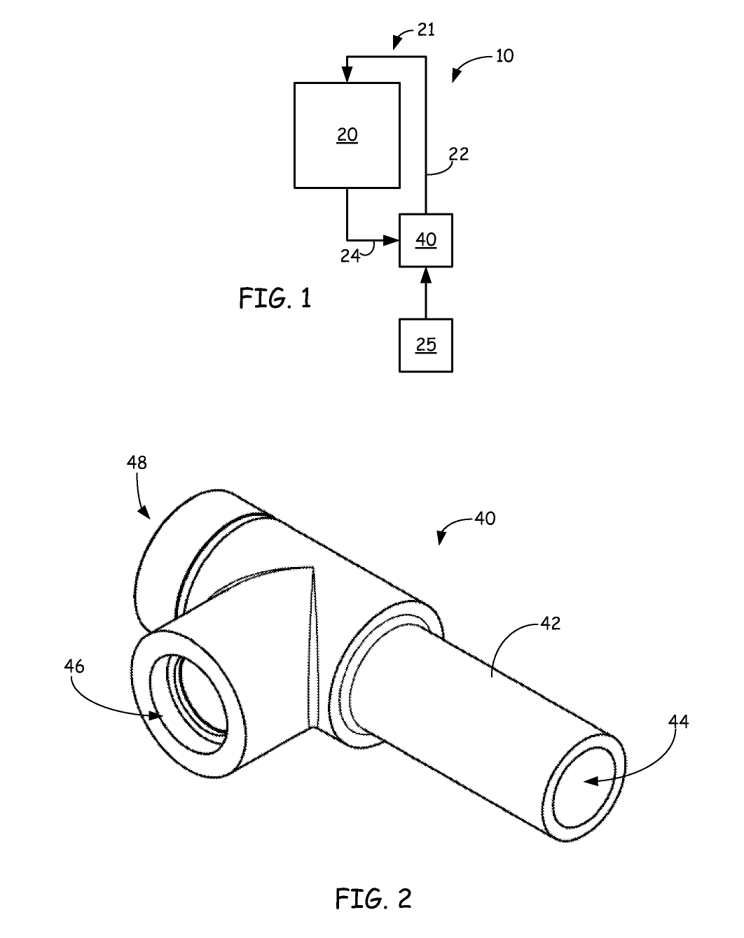

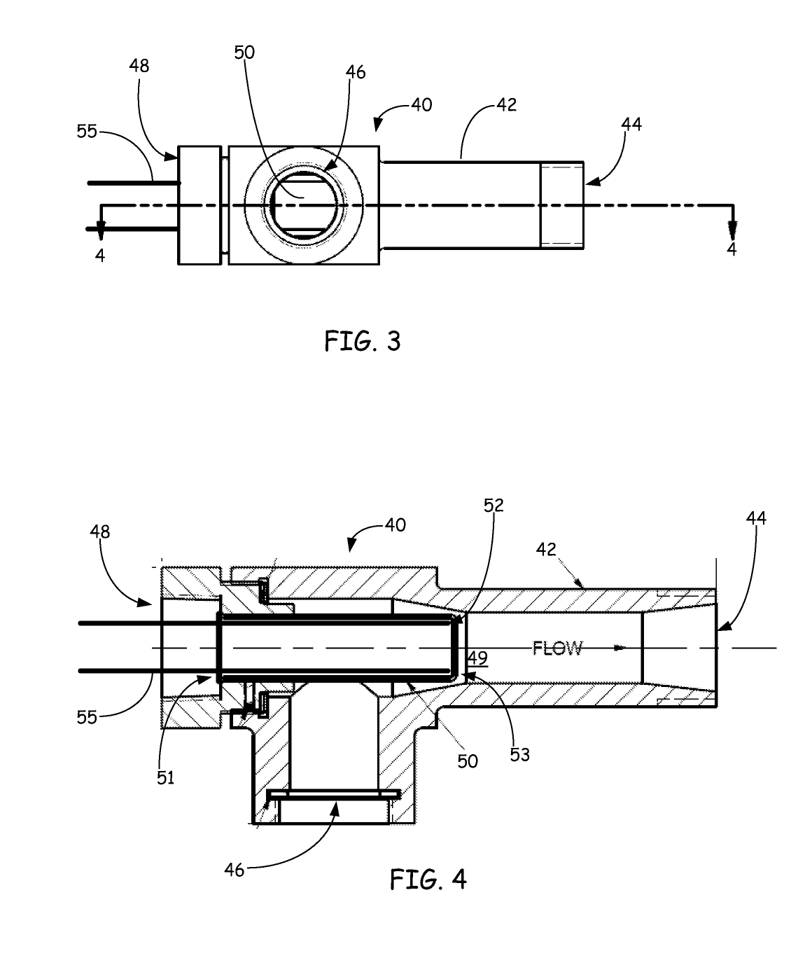

FIG. 1 is a schematic diagram of an illustrative eductor system 10. FIG. 2 is a perspective view of an illustrative eductor body 40. FIG. 3 is a schematic side view of an illustrative eductor body 40. FIG. 4 is a schematic cross-sectional view of an illustrative eductor body 40 taken along line 3-3.

The eductor system 10 can be mounted on a vehicle (e.g., fire fighting vehicle). The eductor system 10 can include a liquid reservoir 20, a liquid recirculation loop or piping 21 to liquid recirculate liquid in the liquid reservoir 20 and an eductor 40 fluidily disposed in the liquid recircuation loop 21. Recirculation suction piping 24 provides liquid to the eductor system 40 and recirculation discharge piping 22 educted liquid back into the liquid reservoir 20. A fluid pump (not shown) can be disposed in the liquid recircuation loop 21 and fluidly between the liquid reservoir 20 and the eductor 40. A solute or pseudoplastic forming composition source 25 is fluidly attached to the eductor 40. The liquid reservoir 20 can further include a discharge connected to a liquid pump to apply the liquid in the liquid reservoir 20 to the desired application.

The eductor 40 includes an eductor body 42 having an eductor outlet 44 and a motive fluid inlet 46 being generally orthogonal to the eductor outlet 44. The motive fluid inlet 46 can be connected to the recirculation suction piping 24 and provided at a high pressure via a liquid pump. The motive fluid inlet 46 can be connected to a water source 20 as the solvent source. The eductor outlet 44 can be connected to the recirculation discharge piping 22 and the educted liquid transported back into the liquid reservoir 20.

A suction nozzel 50 is disposed within the eductor body 42 at the suction inlet 48 and is co-axial with the eductor outlet 44. The suction nozzle 50 extends between a nozzle proximal end 51 and a nozzle distal end 53. The nozzle proximal end 51 can be fixed to the eductor body 42. A suction tube element 55 is slidably disposed within the suction inlet 48 and the suction nozzle 50. In many embodiments, the suction tube element 55 extends to the nozzle distal end 53. In many embodiments, the nozzle distal end 53 includes a shoulder 52 or stop element having a diameter being less than a diameter of the suction nozzle 50. The shoulder 52 or stop element prevents the suction tube element 55 from sliding or extending beyond the nozzle distal end 53. The suction tube element 55 can extend to the shoulder 52. The suction tube element 55 is co-extensive with the suction nozzle 50, as illustrated in FIG. 4. A solute or pseudoplastic forming composition source 25 is fluidly attached to the eductor 40 via the suction tube element 55.

Upon eduction, pseudoplastic composition is disposed or educted into the liquid reservoir 20. The pseudoplastic composition clings to a surface positioned in any orientation 35. The pseudoplastic composition includes starch, a pseudoplastic, high yield, suspending agent, and water.

Once the pseudoplastic composition is disposed or educted into the liquid reservoir 20 the suction tube element 55, and any solute residue remaining in the suction tube element 55, can be slidably is removed from the eductor body. This feature allows the eductor 40 to be easily cleaned and maintained as compared to prior eductors.

The solute or pseudoplastic forming composition source 25 can contain a powder or particulate concentrate and/or a liquid concentrate. Water or liquid from the liquid reservoir 20 is combined or educted with the powder concentrate or liquid concrete compositions to form the pseudoplastic compositions described herein.

In many embodiments, the pseudoplastic compositions include pseudoplastic high yield suspending agents, starch, and a basic neutralizing material, added to water to produce a stable, nonsettling augmentation to water (e.g., an aqueous suspension). In some embodiments, paraffin or olefin is added to the pseudoplastic compositions, as desired. Other materials can be added to the pseudoplastic compositions depending on the desired use of the pseudoplastic compositions, as described below.

The pseudoplastic compositions can be applied to any desired surface. The pseudoplastic compositions have the ability to cling to the surface applied to. In some embodiments the pseudoplastic compositions are applied to surfaces to prevent or suppress or extinguish a fire.

The pseudoplastic composition is easily pumped or sprayed by pumping equipment or by low-pressure individual back tanks. The pseudoplastic composition has a “high yield value,” meaning it has an initial resistance to flow under stress but then is shear thinning (where the viscosity decreases with increasing rate of shear stress), and when used, exhibits “vertical cling,” meaning it has the ability at rest, to immediately return to a suspension or gel. The pseudoplastic composition can be easily sprayed and immediately thickens when it contacts a surface. The pseudoplastic composition's mass and the vertical cling both can act as a heat sink capable of clinging to vertical and overhead surfaces.

For example, the heat sink effect does not allow the temperature of the surface coated with the pseudoplastic composition to exceed about 100 degree centigrade until the water in the pseudoplastic composition has been evaporated. To produce this shear thinning effect and then cling, the composition uses a pseudoplastic high yield-suspending agent.

In many embodiments the pseudoplastic composition is formed from starch, a pseudoplastic, high yield, suspending agent, and a basic neutralizing material. These materials can be mixed or blended utilizing a mixer to obtain a powered composition. It has been found that these compositions quickly form a stable suspension or pseudoplastic composition when combined with water. In many embodiments, the pseudoplastic suspension or composition has a pH in the range of 5.0 to 8.0 and clings to a surface positioned in any orientation. In some useful fire suppression applications the pseudoplastic composition forms an exterior intumescent char coating upon fire contact, while retaining an interior aqueous gel composition.

In many embodiments a powdered composition includes 25-55 wt % pseudoplastic, high yield, suspending agent, 0.001- 65% or 35-65 wt % starch, optionally 0.1-10 wt % paraffin or olefin, and 0.5-15 wt % basic neutralizing material. In many embodiments the composition (e.g., powdered composition) includes 30-50 wt % pseudoplastic, high yield, suspending agent, 0.001-60 or 40-60 wt % starch, optionally 1-5 wt % paraffin or olefin, and 0.5-10 wt % basic neutralizing material.

In many embodiments a liquid concentrate composition includes 10-40 wt % pseudoplastic, high yield, suspending agent, 10-40 wt % starch, 30-60 wt % paraffin or olefin, 0.1-10 wt % surfactant and 0.1-10 wt % basic neutralizing material. In many embodiments a liquid concentrate composition includes 20-30 wt % pseudoplastic, high yield, suspending agent, 20-30 wt % starch, 40-50 wt % paraffin or olefin, 1-5 wt % surfactant and 1-5 wt % basic neutralizing material.

These compositions can be diluted with water to form the pseudoplastic composition (an aqueous pseudoplastic suspension or composition). In many embodiments the pseudoplastic composition includes from 0.1 to 5% wt of the liquid or powder concentrate composition and from 99.9 to 95% wt water. In some embodiments, the pseudoplastic composition includes from 0.5 to 1% wt of the pseudoplastic composition and from 99.5 to 99% wt water. It has been found that the pseudoplastic composition clings to a surface positioned in any orientation, and often forms an exterior intumescent char coating upon fire contact, while retaining an interior aqueous gel composition.

There are many types of pseudoplastic high yield suspending agents or rheology modifiers that can be used successfully in the pseudoplastic composition. Two of the major groups of such suspending agents are laponites, a synthetic smectite clay, and CARBOPOLS™(that are generally high molecular weigh homo- and copolymers of acrylic acid cross linked with a polyalkenyl polyether. Other polymers and synthetic clays are suitable and may be used in combination to develop special pseudoplastic high yield suspending agent characteristics. In using a combination of these suspending agents, synergism is found, for example, between laponites and CARBOPOLS™, where a blend offers improved characteristics for the composition. Thus a pseudoplastic, high yield, suspending agent can include a mixture of an acrylic acid copolymer cross linked with a polyalkenyl polyether (e.g., CARBOPOLS™) and a synthetic smectite clay. Of the group of laponites, which are synthetic smectite clays closely resembling the natural clay mineral hectoritic, it was found that Laponites RD and RDS provide the best performance. Laponites RD and RDS are layered hydrous magnesium silicates that disperse rapidly in water without the need for high shear. Laponites RD and RDS are manufactured by Southern Clay Products, Inc., Gonzales, Tex., and are commercially available from Fitz Chemical Corporation, Itasca, Ill.

In another major group of suspending agents, the CARBOPOLS™, one particularly effective material is CARBOPOLS™ EZ-3, a hydrophobically modified cross-linked polyacrylate powder. The polymer is self-wetting and requires low agitation for dispersion. The convenience of low agitation is very evident in the very short wetting out time needed, when making a concentrate. CARBOPOLS™ EZ-3 is commercially available from Noveon, Inc., Cleveland, Ohio 44141. These materials hold solid particles in suspension without allowing the solids to settle. These materials have a shear thinning rheology so they can be pumped or sprayed onto a surface without the loss of cling. The CARBOPOLS™ EZ-3 is the more efficient of pseudoplastic high yield suspending agents tested and the Laponite RDS one of the fastest to build in viscosity, after shear thinning. The laponites are especially sensitive to electrolytes or the typical salts in water. Many pseudoplastic high yield suspending agents need to be fully dispersed and hydrated in water to achieve the best performance characteristics. The suspension composition improves the overall efficiency of putting fire out with water. Other suitable pseudoplastic, high yield, suspending agents include modified guar and xantham gums, casein, alginates, modified cellulose, including methyl cellulose, hydroxyethyl cellulose, hydroxypropyl cellulose and carbomethyl cellulose, gum tragacanth used individually or in combination.

The pseudoplastic composition have a high yield value with a “shear thinning capacity” which means, the pseudoplastic composition becomes thin when pumped and instantly pseudoplastic or sag resistant, at rest. Thus, after being pumped and sprayed, the pseudoplastic composition is capable of clinging to a vertical or overhead surface. Any starch can be used in the suspension compositions. Examples of starches include corn, wheat, potato, tapioca, barley, arrowroot, rice or any combination of starches.

Dry starch contains about 12% water and has a particle size in a range from 1 to 50 micrometers. As the starch/water mixture is heated, for example by a fire, the starch forms a gel or association with all the surrounding water starting around 70 degrees centigrade. Thus, when the composition is heated, either from the substrate or the air side, the starch absorbs more water at the interface and becomes thicker. On the substrate side, the composition first rides on its own vapor and, as it cools, forms its own film on the substrate surface. On the air side, where evaporation largely occurs, the composition first thickens and then crusts over and eventually is converted to a carbonized char. The char formed is a hard, intumescent coating, which slows the evaporation of water from the composition. In essence, the composition's own film and char act as a vessel to contain the soft-gelled composition, which now acts as a heat sink to cool the backside of the intumescent char. This synergism between the intumescent hard coating and the composition's aqueous gel helps optimize a very limited amount of water. The char/gel coating further reduces the available combustible material to the fire, and also reduces the smoke emission.

Hydrophobic agglomerating material can be added to the composition. It has been found that the hydrophobic agglomerating material improves the material properties as compared to compositions that do not include the composition. While not wishing to be bound to any particular theory, it is believed that the hydrophobic agglomerating material improves the speed at which the aqueous gel or aqueous suspension is formed. In many fire suppression applications, quick formation of the aqueous gel or aqueous suspension is important.

In some embodiments the hydrophobic agglomerating material includes liquid paraffins or olefins. Paraffin is the common name for alkane hydrocarbons with the general formula CₙH₂ₙ₊₂. Liquid paraffin generally have less than 20 carbon atoms. In many embodiments the paraffin has from 10 to 15 carbon atoms and is linear, or has from 14 to 18 carbon atoms and is linear. Olefin is the common name for alkene hydrocarbons with the general formula CₙH₂ₙ where the hydrocarbon is not saturated. In many embodiments the olefin has from 10 to 15 carbon atoms and is linear, or has from 15 to 18 carbon atoms and is linear.

Commercially available paraffins and olefins include BIO-BASE™ 100LF (linear internal olefin with a carbon chain length between C15 and C18), BIO-BASE™ 300 (linear paraffin with a carbon chain length between C11 and C14), BIO-BASE™ 200 (linear alpha olefin with a carbon chain length between C16 and C18), BIO-BASE™ 220 (linear alpha olefin with a carbon chain length between C14 and C16), BIO-BASE™ 250 (linear alpha olefin with a carbon chain length between C14 and C18), BIO-BASE™ 360 (blend of iso-paraffins and linear paraffins with a carbon chain length between C15 and C16), all are available from Shrieve Chemical Products Company (Woodlands, Tex.). It has been found that the presence of the hydrophobic agglomerating material improves the performance of the pseudoplastic composition and reduces the dusting of the composition and reduces the foam generation when the dry composition is combined with water to form the pseudoplastic composition.

The pseudoplastic composition can include a neutralizer (e.g., a basic neutralizing material.) In many embodiments the basic neutralizing material is any material capable of increasing pH when added to an aqueous material (e.g., forming the aqueous suspension). In many embodiments the basic material includes other neutralizers. In many embodiments, starch at least partially encapsulates particles of the neutralizer or basic neutralizing material (e.g., basic neutralizing particles). In some embodiments the basic neutralizing material includes an amino-methyl-propanol (e.g., 2-amino-2-methly-1-propanol). One commercially available alcohol amine is AMP-95™ and is available from Angus Chemical Company, for example.

The compositions can include a surfactant. In many embodiments the surfactant is a non-ionic surfactant. In some embodiments the non-ionic surfactant includes an alkoxylated alcohol non-ionic surfactant. One commercially available alkoxylated alcohol non-ionic surfactant is Delonic™ LF-EP-61 and is available from DeForest Enterprises Inc., (Boca Raton, Fla.) for example.

In some embodiments, the compositions can include a preservative. The preservative can be any useful preservative utilized in any useful amount. In some embodiments, the preservative is commercially available under the trade designation VANCIDE from R.T. Vanderbilt Company, Inc., Norwalk Conn.

Thus, embodiments of the EDUCTOR SYSTEM are disclosed. The implementations described above and other implementations are within the scope of the following claims. One skilled in the art will appreciate that the present disclosure can be practiced with embodiments other than those disclosed. The disclosed embodiments are presented for purposes of illustration and not limitation.

What is claimed is:

1. An eductor system comprising;
an eductor body having an eductor outlet and a motive fluid inlet being generally orthogonal to the eductor outlet;
a suction nozzel disposed within the eductor body and co-axial with the eductor outlet, the suction nozzle extending between a nozzle proximal end and a nozzle distal end, the nozzle proximal end is fixed to the eductor body; and
a suction tube element slidably disposed within the suction nozzle.

2. An eductor system according to claim 1 wherein the suction tube extends to the nozzle distal end.

3. An eductor system according to claim 1 wherein the nozzle distal end comprises a shoulder having a diameter being less than a diameter of the suction nozzle.

4. An eductor system according to claim 3 wherein the suction tube extends to the shoulder.

5. An eductor system according to claim 1 wherein the suction tube is co-extensive with the suction nozzel.

6. An eductor system according to claim 1 further comprising water source fluidly connected to the motive fluid inlet and a pseudoplastic forming composition source attached to the suction tube.

7. An eductor system according to claim 6 wherein the pseudoplastic forming composition comprises;
starch; and
a pseudoplastic, high yield, suspending agent.

8. An apparatus comprising:
a vehicle;
a liquid reservoir disposed on the vehicle;
a liquid recirculation loop fluidly connected to the liquid reservoir to recirculate liquid in the liquid reservoir;
an eductor disposed in the liquid recirculation loop to combine a composition with the liquid, the eductor comprising:
an eductor body having an eductor outlet and a motive fluid inlet being generally orthogonal to the eductor outlet;
a suction nozzel disposed within the eductor body and co-axial with the eductor outlet, the suction nozzle extending between a nozzle proximal end and a nozzle distal end, the nozzle proximal end is fixed to the eductor body; and
a suction tube element slidably disposed within the suction nozzle.

9. An apparatus according to claim 8 wherein the nozzle distal end comprises a shoulder having a diameter being less than a diameter of the suction nozzle and the suction tube extends to the shoulder.

10. An apparatus according to claim 8 wherein the suction tube is co-extensive with the suction nozzel.

11. An apparatus according to claim 8 further comprising a pseudoplastic forming composition source attached to the suction tube.

12. An apparatus according to claim 11 wherein the pseudoplastic forming composition comprises;
starch; and
a pseudoplastic, high yield, suspending agent.

13. An apparatus according to claim 11 wherein the pseudoplastic forming composition forms a pseudoplastic composition in the liquid reservoir and the pseudoplastic composition forms an exterior intumescent char coating upon fire contact.

14. An apparatus according to claim 12 wherein the pseudoplastic, high yield, suspending agent comprises an acrylic acid copolymer cross linked with a polyalkenyl polyether.

15. An apparatus according to claim 8 wherein the vehicle is a firefighting vehicle.

16. A method comprising:
flowing a motive fluid through an eductor to form a low pressure region in the educator;
flowing a pseudoplastic forming composition through a suction nozzle wherein the suction nozzle extends into the low pressure region and the suction nozzle comprises a suction tube element slidably disposed within the suction nozzle; and
combining the pseudoplastic forming composition with motive fluid in the low pressure region to form a pseudoplastic composition that forms an exterior intumescent char coating upon fire contact.

17. The method according to claim 16 further comprising applying the pseudoplastic composition onto a substrate to inhibit or suppress a fire.

18. The method according to claim 16 wherein the pseudoplastic forming composition comprises starch and a pseudoplastic, high yield, suspending agent.

19. The method according to claim 16 further comprising sliding the suction tube element into the suction nozzle to a distal end of the suction nozzle before the flowing a pseudoplastic forming composition through a suction nozzle step.

20. The method according to claim 16 further comprising sliding the suction tube element out of the suction nozzle after the combining step.
